(19) United States
(12) Patent Application Publication
(10) Pub. No.: US 2022/0073309 A1
(43) Pub. Date: Mar. 10, 2022

(54) FOLDING DEVICE FOR A FLAT BLANK

(71) Applicant: IWK Verpackungstechnik GmbH, Stutensee (DE)

(72) Inventor: Markus SPECK, Bruchsal (DE)

(21) Appl. No.: 17/466,036

(22) Filed: Sep. 3, 2021

(30) Foreign Application Priority Data
Sep. 4, 2020 (DE) 10 2020 123 159.8

(51) Int. Cl. B65H 45/12; B31D 5/04; B31F 1/00; B31F 1/24

(52) U.S. Cl. CPC B65H 45/12; B31D 5/04; B65H 2701/176; B31F 1/247; B31F 1/0009

(57) ABSTRACT

A folding device for a flat blank has a plurality of bearing blocks arranged in a row in a first direction, the mutual distance of which can be changed by a drive device and each of which has a support surface for the blank by a holding device. A plurality of folding blades are arranged at a distance next to one another in the first direction, at least one of the folding blades being arranged between immediately adjacent bearing blocks. The folding blades can be adjusted by changing a mutual distance with an additional movement component perpendicular to the blank. Adjacent bearing blocks are coupled in terms of movement via a linkage. The folding blade arranged between adjacent bearing blocks is connected to the linkage so a change in distance between the bearing blocks can be transferred by the linkage to the folding blade for the adjustment thereof.

### FIELD OF THE INVENTION

The invention relates to a folding device for a flat blank, comprising a plurality of bearing blocks arranged in a row, at a distance next to one another in a first direction, the mutual spacing of which can be changed in the first direction by means of a drive device and each of which has a support surface for the blank, a holding device, by means of which the blank is held on the support surfaces, and a plurality of folding blades which are arranged at a distance next to one another in the first direction, at least one of the folding blades being arranged between immediately adjacent bearing blocks and the folding blades being adjustable by changing their mutual distance in the first direction and with an additional movement component perpendicular to the blank.

### BACKGROUND AND SUMMARY OF THE INVENTION

In packaging technology, the problem often arises that a plurality of objects, for example ampoules, have to be securely positioned in a larger outer packaging, for example a box. For this purpose, it is known to insert a folded insert into the box which, due to the folding thereof, has receiving compartments for the ampoules. The insert is usually erected by folding and produced from a flat blank, for example made of cardboard, carton, or plastics material, and then inserted into the box.

EP 0 491 658 B1 describes a method and a device for folding a flat blank in the desired manner. A plurality of bearing blocks arranged in a row and at a distance next to one another are provided, each of which has a support surface on the upper side thereof, on which the blank can be placed. The bearing blocks are adjustable along a linear guide by means of a drive device in the form of a belt drive.

In order to deflect the blank from the flat initial shape thereof, a plurality of folding blades are arranged above the blank, which are adjustable relative to one another along a further linear guide and can also perform a movement perpendicular to the blank via a control link. For the movement of the folding blades, a further drive device is provided. In this way, the folding device is not only very complex in terms of construction, but it also requires a relatively large amount of space.

The object of the invention is to create a folding device of the type mentioned, the structural design of which is simplified and which has a compact design.

This object is achieved according to the invention by a folding device having the features of claim 1. It is provided that the immediately adjacent bearing blocks are coupled in terms of movement to one another via a linkage and that the folding blade arranged between the bearing blocks coupled in terms of movement is connected to the linkage in such a way that a change in distance between the bearing blocks in the first direction can be transferred by means of the linkage to the folding blade for the adjustment movement thereof.

According to the invention, the linkage serves, on the one hand, to synchronize the movement of the bearing blocks with one another. It is therefore only necessary to apply a drive movement to a bearing block or a few bearing blocks, the drive movement being transmitted from the driven bearing block via the respective linkage to the adjacent bearing block. At the same time, the folding blade is connected to the linkage in such a way that the change in distance between the bearing blocks and thus a movement of the linkage is transferred to the assigned folding blade and thus results in the adjustment movement thereof both with a movement component perpendicular to the blank and in the first direction. In this way, it is achieved that no separate drive device is necessary for the folding blade or the folding blades since their adjustment movement is derived from the movement of the bearing blocks.

It is preferably provided that a plurality of bearing blocks and in particular all bearing blocks are coupled in terms of movement to their immediately adjacent bearing block via one of the linkages. In a possible embodiment of the invention, it is achieved that only one bearing block can be adjusted and, in particular, displaced by means of the drive device and that all the other bearing blocks are thereby likewise adjusted or displaced via the frames.

In a possible embodiment of the invention, it is provided that only one drive device is provided, the drive effect of which is transmitted to all bearing blocks. In a preferred embodiment of the invention, it is provided that two drive devices are provided, of which one drive device is connected to the first bearing block of the row of bearing blocks and the other drive device is connected to the last bearing block of the row of bearing blocks.

An intermediate space is formed between immediately adjacent bearing blocks, it being possible in a further development of the invention to provide that at least one of the folding blades is arranged between a plurality of and in particular between all immediately adjacent bearing blocks.

The folding device preferably comprises a support frame with which the folding device can be installed exchangeably in a packaging machine. In a further development of the invention, the support frame comprises at least one linear guide for at least some of the bearing blocks and/or for at least some of the folding blades to ensure a defined movement of the bearing blocks in the first direction and/or the folding blades both in the first direction and with a component vertical thereto.

The linear guide can be formed by a guide rail or guide rod extending in the first direction. A plurality of guide rails or guide rods preferably run parallel to one another at a distance. Preferably, two guide rails or guide rods are assigned to each bearing block and each bearing block is displaceably supported, for example by a spherical bushing, on the guide rails or guide rods assigned thereto. In a further development of the invention, four guide rails or guide rods can be provided, two of the guide rails or guide rods being assigned to a first group of bearing blocks and the other two guide rails or guide rods being assigned to a second group of guide rails or guide rods, and the bearing blocks of the first group and the bearing blocks of the second group being arranged alternately one behind the other. In this way, it can be achieved that the spherical bushings do not hinder the pushing together of the bearing blocks and thus a very small dimension of the pushed together bearing blocks can be achieved.

In a further development of the invention, it can be provided that at least one of the bearing blocks is held immovably relative to the support frame and that at least some of the bearing blocks are adjustable relative to the support frame. The bearing block, which is held immovably relative to the support frame, serves as a counter-bearing for the movement of the bearing blocks in the first direction.

In a possible embodiment of the invention, it can be provided that the first bearing block of the row of bearing blocks or the last bearing block of the row of bearing blocks is held immovably relative to the support frame and that then the drive device engages the opposite bearing block, i.e., in the first case, the last bearing block of the row of bearing blocks and, in the second-mentioned case, the first bearing block of the row of bearing blocks, whereby the bearing blocks arranged between the two outer bearing blocks are also adjusted or displaced when the drive device is activated.

In a preferred embodiment of the invention, it is provided that the central bearing block of the row of bearing blocks or a bearing block arranged in the central region of the row of bearing blocks is held immovably relative to the support frame and that a first drive device engages the first bearing block of the row of bearing blocks and a second drive device engages the last bearing block of the row of bearing blocks.

The drive device can be a pneumatic or hydraulic piston-cylinder unit or a continuously rotating belt, in particular a toothed belt, or a servomotor or a linear motor.

The flat blank is held on the support surfaces of the bearing blocks by means of the holding device. The blank can be subjected to a clamping or compressive force. In a preferred embodiment of the invention, it is provided that the holding device has at least one suction cup. In particular, it can be provided that the suction cup is integrated into the support surface of the bearing block. At least one bearing block and in particular all bearing blocks preferably have one or two suction cups, for example on their upper side, on which a negative pressure can be generated. As soon as the flat blank to be folded is placed on the support surface, the negative pressure is activated, whereby the blank is subjected to a suction force that pulls it against the support surfaces. As a result, the blank is held securely on the support surfaces in all method steps.

The linkage, which connects two directly adjacent bearing blocks to one another, preferably has a plurality of rod-shaped links connected to one another in an articulated manner and is designed in particular as a toggle lever. A toggle lever of the type mentioned can have two pendulum rods mounted in an articulated manner on both sides, each pendulum rod preferably being connected in an articulated manner at the one axial end thereof in a connecting joint to the other pendulum rod and at the other axial end thereof in a bearing joint to one of the bearing blocks.

It can be provided that the linkage has two toggle levers of the type mentioned which are arranged at a distance one above the other.

The folding blade is connected to the linkage or the toggle lever. It can be provided that the folding blade is connected to the toggle lever in the connecting joint.

In a further development of the invention, it can be provided that the folding blade has a folding blade carrier, which is attached to the linkage, and a folding blade head. The folding blade carrier may be formed by a vertically oriented plate. The folding blade head can be held exchangeably on the folding blade carrier, so that an adjustment to different flat blanks to be folded is possible by selecting and replacing corresponding folding blade heads. The folding blade head may have a configuration that tapers to a point and in particular be formed by a bar with a triangular cross-section.

The folding blade head is preferably arranged above the upper of the two toggle levers and can be exchanged without having to dismantle the linkage or the toggle levers.

### BRIEF DESCRIPTION OF THE DRAWINGS

Further details and features of the invention will become apparent from the following description of an embodiment with reference to the drawing. In the drawing:

FIG. 1 is a perspective view of a folding device according to the invention,

FIG. 2 shows the folding device according to FIG. 1 in a side view having the blank placed thereon,

FIG. 3 is an enlarged section of the folding device according to FIG. 2,

FIG. 4 shows the folding device according to FIG. 2 during the adjustment of the bearing blocks, and

FIG. 5 shows the folding device according to FIG. 4 in the completely pushed together position.

### DETAILED DESCRIPTION

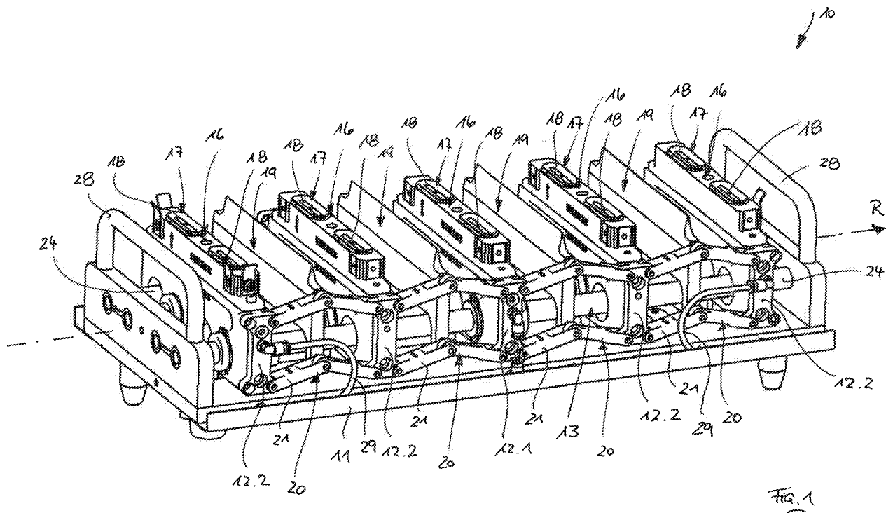

FIGS. 1, 2, and 3 show a folding device 10 for a flat blank Z made of cardboard or carton, which has a transportable support frame 11 which is provided with handles 28 for handling. A linear guide 13 having a plurality of guide rods 24 arranged parallel and at a distance next to one another is mounted on the support frame 11. The guide rods 24 run in a straight line in a first direction R, as indicated by the arrow in FIG. 1.

On the guide rods 24, a plurality of bearing blocks 12.1 and 12.2 are arranged in a row, at a distance next to one another in the first direction R. The central bearing block 12.1 is mounted immovably on the guide rods 24. The other bearing blocks 12.2 are displaceable along the guide rods 24.

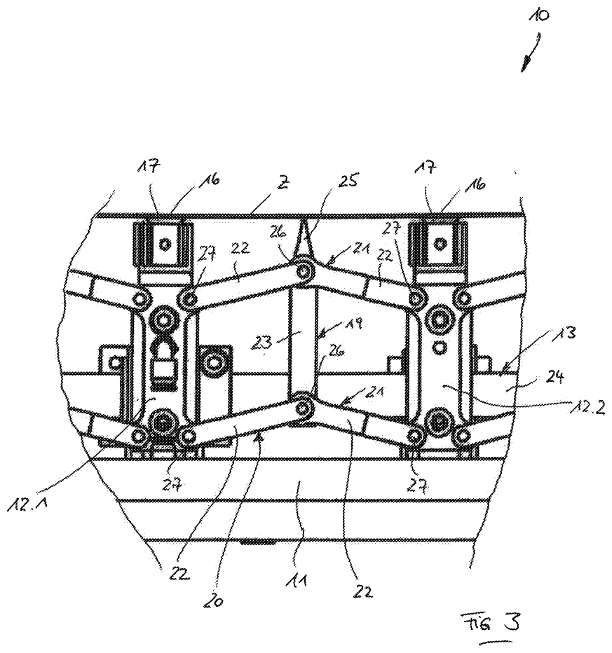

Between two immediately adjacent bearing blocks 12.1, 12.2, a folding blade 19 is arranged, which is also guided displaceably on the guide rods 24. Each folding blade 19 consists of a folding blade carrier 23 (see FIG. 3) and a folding blade head 25 which is held exchangeably on the folding blade carrier 23. The folding blade carrier 23 is formed by a vertically aligned plate and the folding blade head 25 has a configuration that tapers to a point and may be formed by a bar with a triangular cross-section.

Immediately adjacent bearing blocks 11.1, 11.2 are each coupled in terms of movement to one another via a linkage 20. The linkage 20 comprises two toggle levers 21 arranged at a distance vertically one above the other. Each toggle lever 21 has two pendulum rods 22 mounted in an articulated manner on both sides. Each pendulum rod 22 is connected in an articulated manner at the one axial end thereof in a connecting joint 26 to the other pendulum rod 22 and at the other axial end thereof in a bearing joint 27 to the respective bearing block 12.1, 12.2.

Each folding blade 19 is connected in the connecting joint 26 to the associated toggle levers 21. In particular, the folding blade carrier 23 is connected in an articulated manner to the two toggle levers 21, the folding blade head 25 being able to be removed from the folding blade carrier 23 at any time without having to dismount the linkage 20.

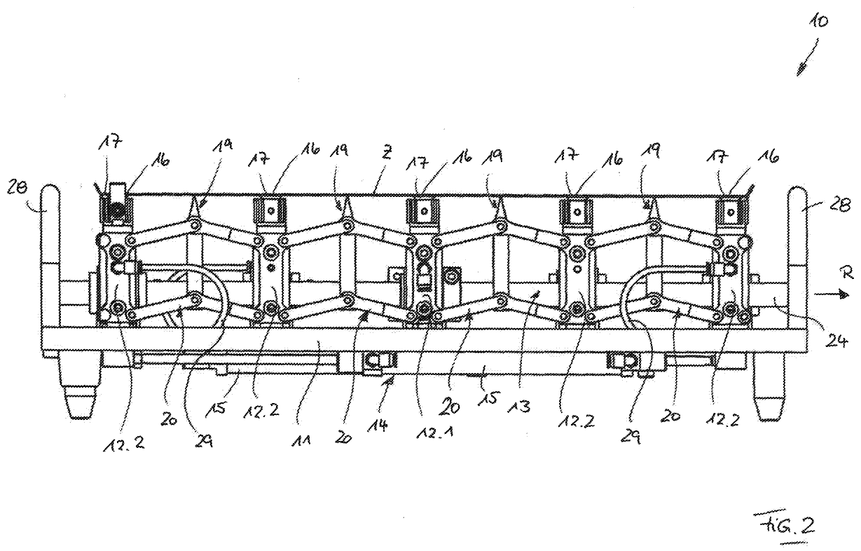

Two drive devices 14 in the form of piston-cylinder units 15 are arranged on the underside of the support frame 11. The piston-cylinder units 15 are each firmly connected at the cylinder thereof to the support frame 11, the free end of the piston being connected to that bearing block 12.2 which is arranged at the end of the row of bearing blocks, i.e., on the one hand, to the left-hand bearing block according to FIG. 2 and, on the other hand, to the right-hand bearing block 12.2 according to FIG. 2.

A holding device 17 for the blank Z is formed on the upper side of the bearing blocks 12.1, 12.2, each of which is formed by two suction cups 18 which are integrated into each bearing block 12.1, 12.2. The suction cups 18 are connected in the usual way via lines 29 to a negative pressure source.

FIG. 2 shows the bearing blocks 12.1, 12.2 in their most expanded state, with a folding blade 19 being arranged between two adjacent bearing blocks 12.1, 12.2. The central bearing block 12.1 is held immovably on the support frame 11.

When the two drive devices 14 are activated, both the left bearing block 12.2 according to FIG. 2 and the right bearing block 12.2 according to FIG. 2 are moved inwardly towards one another along the guide rods 24. This movement is transmitted via the linkage 20 to the bearing blocks 12.2, which are not directly driven. The fixed central bearing block 12.1 remains in place.

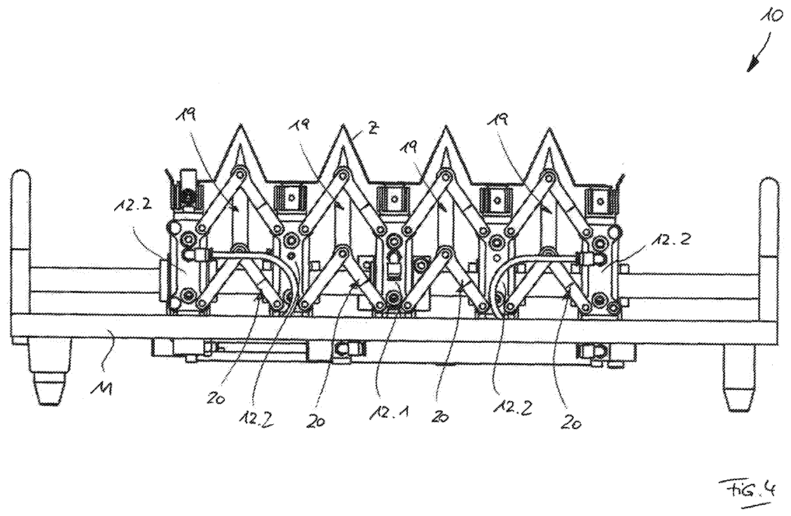

Due to the drive movement of the two outer bearing blocks 12.2, the mutual distance between the bearing joints 27 of the respective toggle levers 21 is reduced, as a result of which the toggle levers 21 deflect upwards, i.e. the respective connecting joint 26 executes an upward movement. As a result, the folding blades 19 articulated to the connecting joints 26 also perform an upward movement, whereby each folding blade head 26 comes into contact with the blank Z resting on the support surfaces 16 and exerts a deforming force thereon perpendicular to the blank plane. The deformation of the blank Z is further supported by moving together the bearing blocks 11.1 and 11.2. This state is shown in FIG. 4.

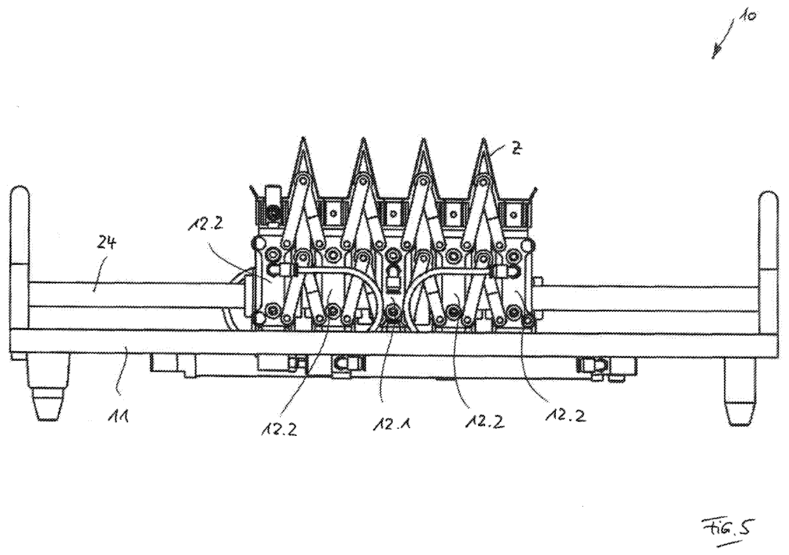

FIG. 5 shows the bearing blocks in their completely pushed together state in which the folding blades 19 protrude upwards and have deformed the blank Z. When the final deformation of the blank Z is achieved, the negative pressure on the suction cups 18 of the holding device 17 is switched off so that the deformed blank Z can be removed from the folding device 10 in an upward direction.

1. A folding device for a flat blank, comprising:
a plurality of bearing blocks arranged in a row, at a distance next to one another in a first direction, a mutual distance of which can be changed by drive device and each of which has a support surface for the blank;
a holding device, by which the blank is held on the support surfaces;
a plurality of folding blades which are arranged at a distance next to one another in the first direction, at least one of the plurality of folding blades being arranged between immediately adjacent bearing blocks and the plurality of folding blades being adjustable by changing mutual distance therebetween in the first direction and with a movement component perpendicular to the blank; and
a plurality of linkages;
wherein immediately adjacent bearing blocks are each coupled in terms of movement to one another via one of the linkages and one of the folding blades arranged between the bearing blocks coupled in terms of movement is connected to the one of the linkages in such a way that a change in distance between the bearing blocks in the first direction can be transferred by the one of the linkages to the one of the folding blades for adjustment movement thereof.

2. The folding device according to claim 1, wherein all of the bearing blocks are coupled in terms of movement to the immediately adjacent bearing block thereof via one of the linkages.

3. The folding device according to claim 1, wherein at least one of the folding blades is arranged between all immediately adjacent bearing blocks.

4. The folding device according to claim 1, further including a support frame which has at least one linear guide for at least some of the bearing blocks and/or for at least some of the folding blades.

5. The folding device according to claim 4, wherein at least one of the bearing blocks is held immovably relative to the support frame and at least some of the bearing blocks are adjustable relative to the support frame.

6. The folding device according to claim 1, wherein the drive device engages one of the bearing blocks which is arranged at an end of the row of the bearing blocks.

7. The folding device according to claim 1, wherein the drive device engages in each case on both of the bearing blocks which are arranged at an end of the row of the bearing blocks.

8. The folding device according to claim 1, wherein the drive device is a piston-cylinder unit or a continuously rotating belt or a servomotor or a linear motor.

9. The folding device according to claim 1, wherein the holding device has at least one suction cup.

10. The folding device according to claim 9, wherein the at least one suction cup is integrated into the support surface of an associated one of the bearing blocks.

11. The folding device according to claim 1, wherein each of the linkages has at least one toggle lever.

12. The folding device according to claim 11, wherein the at least one toggle lever has two pendulum rods mounted in an articulated manner on both sides, each first ones of the pendulum rods being connected in an articulated manner at a first axial end thereof in a connecting joint to each second ones of the pendulum rods and at a second axial end thereof in a bearing joint to one of the bearing blocks.

13. The folding device according to claim 12, wherein each of the linkages has two toggle levers arranged at a distance one above the other.

14. The folding device according to claim 12, wherein the folding blade is connected to one of the linkages in the connecting joint.

15. The folding device according to claim 1, wherein each of the folding blades has a folding blade carrier attached to one of the linkages and has a folding blade head.

16. The folding device according to claim 15, wherein the folding blade head is held exchangeably on the folding blade carrier.
